(19) United States
(12) Patent Application Publication
(10) Pub. No.: US 2009/0089941 A1
(43) Pub. Date: Apr. 9, 2009

(54) Process for Creating Composite Materials to Produce Polymer Nanocomposite Films that Exhibit Improved Light Fastness Properties

(75) Inventors: Hans-Conrad zur Loye, Columbia, SC (US); Tara Hansen, League City, TX (US); Arthur Peter Barber, III, West Columbia, SC (US); John W. Stone, Nashville, TN (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 11/911,037

(22) PCT Filed: Apr. 10, 2006
(86) PCT No.: PCT/US06/13258

§ 371 Date: Nov. 18, 2008

Related U.S. Application Data
(60) Provisional application No. 60/669,645, filed on Apr. 8, 2005.

(51) Int. Cl. D06P 7/00; C08K 3/10; C08K 5/23; C08K 3/34; C08K 3/22; C08K 3/32; D06P 3/00

(52) U.S. Cl. 8/506; 524/413; 524/456; 524/190; 524/442; 524/444; 524/401; 524/414

(57) ABSTRACT

The present invention relates to new methods of producing polymer composite materials. More specifically, the invention involves a process in which layered materials including clays and other inorganic materials are dispersed into polymer systems to create polymer nanocomposite films. The resulting films exhibit improved resistance to fading when compared to polymer films that lack the additional layered materials.

### CROSS-REFERENCE TO RELATED APPLICATIONS

The present application claims priority to U.S. Provisional Patent Application No. 60/669,645 filed on Apr. 8, 2005, titled “Process for Creating Composite Materials to Produce Polymer Nanocomposite Films that Exhibit Improved Light Fastness Properties” and naming Hanno zur Loye, et al. as inventors, which is hereby incorporated by reference.

### BACKGROUND OF THE INVENTION

Polymer nanocomposites have recently attracted much attention due to their significantly improved mechanical and physical properties compared to the pristine polymer and other conventional micron sized composites. Nanoscaled layer silicates such as montmorillonite and hectorite have been used as modifiers in a variety of polymeric matrices to produce nanocomposites. These materials have manifested higher modulus, better dimensional stability, and improved gas barrier and flame retardation.

In the past, naturally occurring clays have been incorporated into polymers for improving the barrier properties of the material. The natural occurring clays, however, typically have to be cleaned and then chemically modified in order to disperse the clay particles into the polymeric matrix. Instead of incorporating naturally occurring clay particles into polymers, however, the present invention is directed to using synthetic oxide materials and/or synthetic metal phosphonates. As used herein, the term “synthetic” refers to the fact that the particles are synthesized artificially or are man-made.

Polymeric materials are used in an almost limitless variety of applications. For instance, thermoplastic polymers are used to form films, fibers, filaments, and may also be molded or extruded into various useful articles. In many applications the polymeric materials include a dye or other colorant within the polymeric matrix. However, research has shown that these polymers alone, when dyed and exposed to light, exhibit fading.

As such, a need exists for a dyed or otherwise colored polymeric material that has improved light fastness. Also, a need exists for a dyed or colored polymeric material that resists fading without significantly changing the properties of the polymeric material.

### SUMMARY OF INVENTION

In one embodiment, the present invention is generally directed to a colored polymeric material comprising a polymer, synthetic nanoparticles, and a colorant. The synthetic nanoparticles can be selected from the group consisting of synthetic oxide particles and metal phosphate particles. The colored polymeric material has increased light fastness when compared to an otherwise identical colored control polymeric material without the synthetic nanoparticles. For example, the colorant can comprise a dye, such as an acid dye and/or an azo dye. For instance, the dye can be susceptible to degradation when exposed to light in the presence of oxygen.

In one particular embodiment, the synthetic nanoparticles can comprise synthetic oxide particles having a greatest dimension of less than about 5,000 nm. The synthetic nanoparticles can be selected from the group consisting of synthetic phyllosilicate particles and synthetic layered perovskitite particles. For example, in one particular embodiment, the synthetic nanoparticles can comprise smectites, such as hectorites.

In another embodiment, the present invention is generally directed to a method of making a colored polymeric material having increased light fastness. The method comprises exfoliating synthetic nanoparticles into a polymeric material and dying the polymeric material with a dye. The synthetic nanoparticles can have a greatest dimension of less than about 5,000 nm and be selected from the group consisting of synthetic oxide particles and metal phophonate particles. The dye can be susceptible to degradation when exposed to light in the presence of oxygen.

Other features and aspects of the present invention are discussed in greater detail below.

### BRIEF DESCRIPTION OF THE FIGURES

FIG. 1 is a graph of the results of a control polyvinyl alcohol film containing acid red #111 without any hectorite compared to a dyed polyvinyl alcohol film containing acid red #111 and hectorite; and

FIG. 2 is a graph of a control agarose film containing acid red #111 without any hectorite compared to an agarose film containing acid red #111 and hectorite.

### DETAILED DESCRIPTION

It is to be understood by one of ordinary skill in the art that the present discussion is a description of exemplary embodiments only, and is not intended as limiting the broader aspects of the present invention.

In general, the present invention is directed to colored polymer composite materials that have improved light fastness. In addition to improved light fastness, however, it should be understood that the composite polymeric materials may also exhibit other improved properties, such as improved gas barrier properties For instance, the composite materials may be formulated to have physical properties that are particularly well suited for a specific application. The invention shows that a colored polymer nanocomposite film created by adding the synthetic nanoparticles to a polymer exhibits enhanced light fastness properties over the colored polymer alone.

For instance, when exposed to light (e.g., natural light, visible light, and/or ultra violet light), the dyed or otherwise colored polymer/nanoparticle composite can exhibit reduced fading when compared to the same dyed or otherwise colored polymer matrix without the presence of such nanoparticles. However, the present inventors have found that through careful selection of synthetic nanoparticles and colorants, the light fastness of the colorant in the polymeric material can be increased.

The dyed or otherwise colored polymeric composite materials generally include a polymer material containing nano-sized synthetic particles and a colorant. For example, the particles dispersed throughout the polymer matrix can comprise synthetic oxide particles and/or metal phosphonate particles, such as those disclosed in International Application No. PCT/US05/26200, filed on Jul. 22, 2005, which is hereby incorporated by reference. These synthetic particles have been found to more easily exfoliate into the polymer matrix in comparison to many conventional materials, such as naturally occurring clays. Further, these particles may be synthesized without containing any significant quantities of impurities.

The synthetic particles may, generally, have a plate-like shape. For example, the particles may have a thickness of less than about 10 nm, such as less than about 5 nm when exfoliated. In one embodiment, the particles can have a thickness of less than about 3 nm, such as less than about 2 nm, such as about 1 nm.

The particles may have a largest dimension of less than about 3,000 nm, such as less than about 2,000 nm, or less than about 1,000 nm. For instance, the particles may. have a diameter or greatest dimension in the range of from about 5 nm to about 3,000 nm, such as from about 10 nm to about 2,000 nm. For example, in one embodiment, the particles may have a diameter or greatest dimension of from about 100 nm to about 1,000 nm, such as from about 250 nm to about 750 nm. The particles may have a thickness of less than about 3 nm, such as less than about 2 nm, such as about 1 nm. For example, in one embodiment, the particles may have the thickness of about 1 nm and have a length and width of from about 250 nm to about 750 nm. In one particular embodiment, the particles may have a thickness of about 1 nm, may have a length of about 500 nm, and may have a width of about 500 nm.

### Synthetic Oxide Particles

In one embodiment, the particles dispersed throughout the polymer matrix can comprise synthetic oxide particles. Synthetic oxides useful in the present invention include any synthetic oxides that are capable of being exfoliated into a polymer. Various synthetic oxide particles may be used in accordance with the present invention. In one particular embodiment, for instance, the synthetic oxide particles comprise a synthetic phyllosilicate. In an alternative embodiment, the synthetic oxide particles comprise synthetic layered perovskite particles.

One example of synthetic phyllosilicates that may be used in the present invention include smectite material. Smectites are one of the largest classes of the phyllosilicate group. In general, a phyllosilicate is dioctahedral if two of the octahedral sites are occupied by trivalent cations, and trioctahedral if all three octahedral sites are filled with divalent cations. In some applications, the synthetic oxide particles used in the present invention comprise trioctahedral smectites. The smectite may be, for instance, a hectorite.

Hectorite generally has a 2:1 layered structure, where each layer is made up of two tetrahedral silicate sheets that sandwich a central metal oxygen octahedral layer. In between each layer resides an exchangeable cation, such as lithium, to balance the overall negative charge of the layer. As used herein, the term “hectorite” is intended to include all hectorite materials, hectorite-like materials, and chemically modified hectorite materials.

Synthetic hectorite particles, in one embodiment, may be represented by one of the following formulas:

Ex_{x/n}ⁿ⁺[Mg₆₋ₓLiₓ][Si₈]O₂₀(OH,F)₄•nH₂O

Ex_{x/n}ⁿ⁺[Mg₆₋ₓLiₓ][Si₈]O₂₀(OH)₄•nH₂O

wherein EX comprises an exchangeable cation, such as a Group I metal, a Group II metal, or an organic cation. For example, in various embodiments, the exchangeable cation may comprise sodium, potassium, or lithium. In other embodiments, however, the exchangeable cation may be derived from an organic salt, such as an alkyl ammonium cation. The organic cation may comprise an alkyl ammonium cation, such as tetra ethyl ammonium (TEA). Particular examples of hectorites according to the above formula that may be used in the present invention include lithium hectorite, TEA hectorite, sodium hectorite, potassium hectorite, and mixtures thereof.

Of particular advantage, the exchangeable cation incorporated into the synthetic hectorite may be selected in order to produce synthetic particles having particular characteristics and properties. For instance, the exchangeable cation may be selected so as to produce particles having a particular size, having a particular shape, having a particular color, and the like. Selection of the exchangeable cation may also impact the ease by which the particles may be exfoliated into a liquid or other material. Depending upon the particular polymer that is to be mixed with the particles, selection of the exchangeable cation may also affect the compatibility of the particles with the polymer.

In one embodiment, the above hectorite particles may be modified for many different purposes, such as to improve the compatibility of the material with a particular polymer. In one embodiment, the hectorite materials may be organically modified, For example, the edges and/or the faces of the hectorite particles may be chemically modified. For example, in one particular embodiment, a silane may be incorporated into the hectorite structure, such as incorporated into the hectorite synthesis to modify the hectorite edges and faces.

Silane-functionalized hectorite may be synthesized by, for instance, incorporating an organotrialkoxysilane into the hectorite material. Particular examples of silanes that may be incorporated into the hectorite material include tetraethoxysilane or phenyltriethoxysilane. The organo groups as described above may become incorporated between the layers of the hectorite structure.

Specifically, one or more of the hydroxy (OH) groups may be replaced by an organic group (R group). The R group may be, for instance, an alkyl group such as a methyl group or an aromatic group such as a phenyl group. In the case of phenyltriethoxysilane modified hectorite, phenyl groups become present between the layers. These phenyl groups can be further modified if desired. Organically modifying the hectorite structure may create a material that more easily exfoliates.

In another embodiment, the phyllosilicates used according to the present invention comprise saponite or stevensite materials. Saponite materials may be made according to the following formula:

Ex_{x/n}ⁿ⁺[Mg₆][Si₈₋ₓAlₓ]O₂₀(OH)₄•nH₂O

Stevensite materials may be made according to the following formula:

Ex_{x/n}ⁿ⁺[Mg₆₋ₓVacancyₓ][Si₈]O₂₀(OH)₄•nH₂O

In addition to phyllosilicates, in an alternative embodiment, the synthetic oxide particles comprise synthetic perovskites, and particularly synthetic layered perovskites. Synthetic perovskites that may be used in the present invention, for instance, include Dion-Jacobson perovskites, Ruddlesden-Popper perovskites, and Aurivillius perovskites. It should be understood, however, that in addition to the above perovskites, the term “perovskite” as used herein is intended to include all perovskite structures and all perovskite-related oxides. Layered perovskites maintain an octahedral network in only two directions, forming 2-dimensional perovskite-like sheets separated by a layer of cations.

For exemplary purposes, Dion-Jacobson perovskites may be indicated as follows:

A(A′ₙ₋₁BₙX₃ₙ₊₁),

Ruddlesden-Popper perovskites may be represented as follows:

A₂(A′ₙ₋₁BₙX₃ₙ₊₁)

and Aurivillius perovskites may be represented as follows:

Bi₂O₂(A′ₙ₋₁BₙX₃ₙ₊₁)

In the above formulas, A and A′ represent mono or divalent cations. For example, the A and/or A′ cations may comprise a Group I metal or a Group II metal. In other embodiments, an organic cation may be used, such as an alkyl ammonium. Examples of alkyl ammonium cations include tetra butyl ammonium (TBA) or tetra ethyl ammonium (TEA). B in the above formulas comprises a cation, such as a multivalent cation. B, for instance, can be a Group II metal or a transition metal. For instance, in one embodiment, B is niobium or titanium. X in the above formulas represents an anion. For many applications, for instance, X is an oxygen atom. In other embodiments, X may be a halide.

Particular examples of Dion-Jacobson layered perovskites that may be synthesized and used in accordance with the present invention include KCa₂Nb₃O₁₀ or TBA-Ca₂Nb₃O₁₀.

Similar to the hectorites, the choice of A, B and X in the above formulas may have an impact upon the type of particles that are produced. Of particular advantage, since the particles are synthesized, A, B and X may be varied in order to produce particles that are particularly well suited for a particular application.

In many embodiments, A, A′, and B are all metal cations. For example, A and/or A′ may comprise a Group I or a Group II metal. B may, in some embodiments, comprise a +2 to +6 metal.

Prior to being incorporated into a polymer matrix, in one particular embodiment, the synthetic layered perovskite may undergo a proton exchange with an organic cation. Specifically, A in the above formula may be replaced by an organic cation, such as an alkyl ammonium cation. For example, in one embodiment, the ammonium cation may comprise tetra (n-butyl) ammonium.

The synthetic oxide particles used in the present invention may be synthesized according to any suitable method that produces particles with the desired characteristics, In one embodiment, for instance, when producing hectorite particles, a lithium salt, a magnesium salt, and a silica source are reacted together optionally in the presence of another metal or organic salt.

For example, when producing lithium hectorite, a lithium salt such as LiF or LiOH may be combined with magnesium hydroxide and a silica source such as a silica gel, a silica sol or tetraethoxy silane. The mixture may be combined in water and refluxed for from about 12 hours to about 3 days. Alternatively, the mixture may undergo a hydrothermal treatment for approximately 12 hours.

In order to produce other synthetic hectorite particles, other metal or organic salts such as sodium chloride, potassium chloride, or tetra ethyl ammonium chloride may be incorporated into the initial reactants. Inclusion of the above metal or organic salts produce sodium hectorite, potassium hectorite, and TEA hectorite respectively.

Many synthetic layered perovskites, on the other hand, may be synthesized using a conventional solid state reaction. For example, in order to produce KCa₂Nb₃O₁₀, K₂CO₃, CaCO₃, and Nb₂O₅ may be combined and heated to a temperature greater than about 1000° C., such as from about 1100° C. to about 1200° C. for from about 24 to about 48 hours.

### Metal Phosphonates

In accordance with the present invention, the particles dispersed throughout the polymer matrix can comprise metal phosphonate particles.

Metal phosphonates useful in the present invention may be indicated by the following formula:

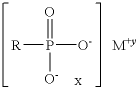

wherein M is a metal cation and R may be any suitable organic group. R can vary dramatically depending upon the particular application and the desired results. For instance, R may be an alkane, an aromatic group such as a phenyl group, or any suitable functional group. In one embodiment, for instance, R is a carboxy alkyl group, such as a carboxy ethyl or carboxy methyl group,

The metal cation present in the phosphonate may comprise any suitable metal. The metal cation, for instance, may have a valence of +1 to about +5, and particularly from about +2 to about +4. The metal cation, for instance, may comprise a Group II metal or a transition metal. Particular examples of metal cations that may be used to produce the phosphonate include titanium, barium, zinc, zirconium, hafnium, calcium, strontium, and the like.

Of particular advantage, the R group and the metal cation for the metal phosphonate may be selected in order to produce phosphonate particles having particular characteristics and properties. For instance, the R group and the metal cation may be selected so as to produce particles having a particular size, having a particular shape, having a particular color, and the like. Selection of the R group and the metal cation also may impact the ease by which the particles may be exfoliated in a liquid or other material. Depending upon the particular polymer that is to be mixed with the particles, selection of the R group and the metal cation may also affect the compatibility of the particles with the polymer.

Particular examples of metal phosphonates that may be used in the present invention include titanium carboxy ethyl phosphonate, titanium phenyl phosphonate, barium phenyl phosphonate, and zinc carboxy ethyl phosphonate.

As described above, selection of the metal cation and the organic group associated with the phosphonate may be used to control the resulting size of the metal phosphonate particles.

The metal phosphonate particles used in the present invention may be synthesized according to any suitable method that produces particles with the desired characteristics. In one embodiment, for instance, the phosphonate particles may be synthesized by reacting a phosphonic acid with a metal salt. Phosphonic acids have the general formula ROP(OH)₂, wherein the R group is the organic group incorporated into the phosphonate as explained in the metal phosphonate formula above. In producing the metal phosphonate, for instance, the metal salt may first be incorporated into an acidic solution and then combined with an aqueous solution containing the phosphonic acid. Refluxing the mixture for a sufficient amount of time causes the metal phosphonate to form as a resulting precipitate. For example, a precipitate may form almost instantaneously after refluxing begins, such as in about 5 minutes. Increasing the time the mixture is refluxed, however, may improve the crystallinity of the product. Thus, in some embodiments, the mixture may be refluxed for an amount of time of from about less than an hour to about 48 hours or longer.

In some instances:, extended reflux times have also been found to have an effect on the resulting morphology of the material. For example, the present inventors have discovered that refluxing a sample for more than about 4 days, such as about 6 days, leads to a more plate-like morphology as opposed to a more rod-like morphology. In particular, the plate-like particles were found to have a more square-like shape as opposed to the same material produced by refluxing for a shorter amount of time. The precipitate may be washed several times and dried prior to being incorporated into a polymer matrix.

In one particular embodiment, for example, titanium tetra chloride (TiCl₄) may be added to an acidic solution, such as a 6M HCl solution, in order to prevent hydrolysis of the metal. The metal salt solution is then combined with an aqueous solution containing 2-carboxyethylphosphonic acid and refluxed for 48 hours causing titanium carboxy ethyl phosphonate to form.

In other embodiments, titanium phenyl phosphonate may be synthesized by refluxing phenyl phosphonic acid and an acidic solution of titanium tetra chloride. Barium phenyl phosphonate may be synthesized by refluxing phenyl phosphonic acid and barium chloride in water. Zinc carboxy ethyl phosphonate may be synthesized by refluxing 2-carboxyethylphosphonic acid and Zn(NO₃)₂.6H₂O in a 5% water/acetone mixture for 2 hours letting the acetone slowly evaporate. After the acetone is evaporated, fresh water is added to form the metal phosphonate.

### Exfoliation into Polymer Matrix

The synthetic oxides and metal phosphonates that are synthesized as described above generally are in the form of relatively large agglomerations after formation. The agglomerations have a layered structure. When the particles are to be incorporated into a polymer for improving the light fastness properties of the colored polymer, the layered structures may be broken down in a process known as exfoliation. During exfoliation, the layered structure is broken down such that the resulting particles have a thickness in the nanometer size range. Of particular advantage, the synthetic oxides and metal phosphonates may be exfoliated in a relatively simple process without having to treat the synthetic oxides or metal phosphonates with various chemical additives.

After exfoliation, the particles may be present in individual layers or may be present as tactoids which may contain from about 2 to about 20 layers of the material. Exfoliation according to the present invention may occur in various carrier materials. For instance, the carrier material may be a liquid or a solid. In one particular embodiment, the particles may be exfoliated directly into a polymer during melt processing.

In one embodiment, the particles may be easily exfoliated into various liquids. The liquids may then be incorporated into a polymer, for instance, during formation of the polymer.

For example, synthetic oxide particles and metal phosphonate particles have been found to be easily exfoliated into liquids such as aqueous solutions, water, liquid glycols, or various other solvents. Once exfoliated into the liquid, a suspension forms that is relatively stable. The suspension may contain an ingredient that reacts with a monomer to form a polymer or may otherwise be present during the polymerization of a polymer. In this manner, the particles may be incorporated into any polymeric material that is capable of being polymerized in the presence of a liquid. Such polymers include polymers that form in a solution polymerization process or in an emulsion polymerization process. In other embodiments, the particles may be incorporated into a polymer that is dissolved in a liquid and later reformed.

In one particular embodiment, for instance, the particles are exfoliated in an aqueous solution. The aqueous solution may consist essentially of water or may contain water and other liquids. For example, in one embodiment, a base may be added in order to facilitate exfoliation. The base may be, for instance, an organic base or a metal hydroxide, such as sodium hydroxide. In other embodiments, however, a base may not be needed.

Once the particles are added to the aqueous solution, the solution may be subjected to various physical forces until the particles are substantially exfoliated. For example, the solution may be subjected to shear forces by stirring the solution or by sonicating the solution. In general, as many particles as possible are added to the aqueous solution. For instance, the particles may be added until the solution has reached its maximum carrying capacity. For many applications, for instance, the particles may be added to the aqueous solution in an amount up to about 10% by weight, such as in an amount up to about 5% by weight. In one embodiment, for example, the particles may be added to the aqueous solution in an amount from about 1% to about 2% by weight.

The percentage of particles that become exfoliated in the aqueous solution depends on various factors, including the particular synthetic oxide and/or metal phosphonate that is used. In general, it is believed that at least 80% of the particles may become exfoliated in the liquid, such as at least about 85% of the particles. As described above, once exfoliated, the particles are in the form of a single layer of the material or in the form of tactoids containing a relatively small amount of layers, such as less than about 20 layers. After exfoliation, various physical means may be used in order to remove any larger particles. For example, the larger particles may settle out and be removed or the solution may be centrifuged in order to remove the larger particles.

The resulting suspension has been found to be relatively stable. In order to be incorporated into a polymer material, the aqueous suspension may be mixed with a polymer during extrusion, mixed with a monomer which is then polymerized into a polymer, or may be combined with a solution containing a dissolved polymer for later forming films and the like.

In addition to aqueous solutions, the particles may also be exfoliated into other liquids. For example, when exfoliating the particles into a polyester, such as PET, the particles may first be exfoliated into ethylene glycol. Ethylene glycol has been found to act as a swelling agent that causes the individual particles to swell and break apart when subjected to shear forces, such as during sonication. After exfoliation, an ethylene glycol suspension containing the particles is formed. Again the suspension may contain the particles in an amount up to about 5% by weight, such as in an amount up to about 2% by weight. Further, the suspension may be centrifuged in order to remove any particles that are not exfoliated.

Of particular advantage in this embodiment, ethylene glycol is an original reactant in the formation of PET polymers. Thus, the ethylene glycol suspension may be combined with a PET monomer, such as bishydroxyethylterepthalate. The monomer and ethylene glycol suspension may then be heated in the presence of a catalyst to create a PET polymer. Through this process, the particles become well dispersed throughout the PET polymer matrix. Once present in the matrix, the particles dramatically improve the gas barrier properties of the material. Also, as the present inventors have found, the particles can improve the light fastness of a polymeric material including a colorant.

In one embodiment, in order to facilitate exfoliation of synthetic oxide particles, the particles may undergo a proton exchange with, for instance, an organic cation. The proton exchange may occur, for instance, with the exchangeable cation present in the synthetic particles. In one particular embodiment, for instance, the layered perovskite KCa₂Nb₃O₁₀ may undergo proton exchange with nitric acid (HNO₃) and exfoliated by reaction with tetra (n-butyl) ammonium hydroxide. After proton exchange, the perovskite may be represented by the following formula:

TBAₓH₁₋ₓCa₂Nb₃O₁₀.

The resulting particles may be exfoliated in a colloidal suspension in, for instance, ethylene glycol or an aqueous solution as previously described.

Exfoliating the particles into a liquid prior to being combined with a polymer ensures that the particles are well dispersed throughout the polymer. In other embodiments, however, the particles may be added directly to an extruder or otherwise melt processed with a thermoplastic polymer. In this embodiment, the particles may be combined with the thermoplastic polymer while the thermoplastic polymer is in a molten state and while the materials are under high shear forces, such as may occur in a screw extruder. In this manner, the particles may be exfoliated into the polymer without the necessity of first exfoliating the particles into a liquid.

As described above, in still another embodiment of the present invention, the particles may be exfoliated in a liquid, such as an aqueous solution that contains a soluble polymer. Once the particles are exfoliated in the liquid, the liquid may be used to form polymeric articles, such as films. In one particular embodiment, for instance, the particles may be dispersed in a solution that contains agarose or polyvinyl alcohol in an amount less than about 10% by weight, such as less than about 5% by weight. For example, in one embodiment, the solution may contain one of the polymers in an amount of about 1% by weight. The particles may be incorporated into the solution in an amount up to about 80% by weight, such as from about 20% by weight to about 50% by weight. Of particular advantage, films made containing up to 50% by weight of the particles remain transparent even at the relatively high particle loading.

### Polymeric Materials

In general, the particles may be added to any polymeric material that is compatible with the particles. The particles may be added to the polymer in order to improve the light fastness of the polymer when colored or to otherwise change the physical properties of the material (e.g., the gas barrier properties). A non-exhaustive list of polymers that may be combined with the particles include polyesters such as PET, polyetheresters, polyamides, polyesteramides, polyurethanes, polyimides, polyetherimides, polyureas, polyamideimides, polyphenyleneoxides, phenoxy resins, epoxy resins, polyolefins such as polyethylenes and polypropylenes, polyacrylates, polystyrenes, polyethylene-co-vinyl alcohols polyvinyl chlorides, polyvinyl alcohols, cellulose acetates, agarose, and the like. The particles may also be added to combinations of polymers. The polymers may comprise homopolymers, copolymers, and terpolymers. The polymers may be branched, linear, or cross-linked.

In one particular embodiment, the particles are incorporated into a polyethylene terephthalate or a copolymer thereof. The polyester may be prepared from one or more of the following dicarboxylic acids and one or more of the following glycols. Also, in one embodiment, the polyethylene terephthalate can be a water-soluble polyethylene terephthalate.

The dicarboxylic acid component of the polyester may optionally be modified with up to about 50 mole percent of one or more different dicarboxylic acids. Such additional dicarboxylic acids include dicarboxylic acids having from 3 to about 40 carbon atoms, and more preferably dicarboxylic acids selected from aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. Examples of suitable dicarboxylic acids include phthalic acid, isophthalic acid, naphthalene-2,6-dicarboxylic acid, cyclohexanedicarboxylic acid, cyclohexanediacetic acid, diphenyl-4,4′-dicarboxylic acid, phenylene (oxyacetic acid) succinic acid, glutaric acid, adipic acid, azelaic acid, sebacic acid, and the like. Polyesters may also be prepared from two or more of the above dicarboxylic acids.

Typical glycols used in the polyester include those containing from two to about ten carbon atoms. Preferred glycols include ethylene glycol, propanediol, 1,4-butanediol, 1,6-hexanediol, 1,4-cyclohexanedimethanol, diethylene glycol and the like. The glycol component may optionally be modified with up to about 50 mole percent, preferably up to about 25 mole percent, and more preferably up to about 15 mole percent of one or more different diols. Such additional diols include cycloaliphatic diols preferably having 3 to 20 carbon atoms or aliphatic diols preferably having 3 to 20 carbon atoms. Examples of such diols include: diethylene glycol, triethylene glycol, 1,4-cyclohexanedimethanol, propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di-(2-hydroxyethoxy)-benzene, 2,2b-is-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane and the like. Polyesters may also be prepared from two or more of the above diols.

Small amounts of multifunctional polyols such as trimethylolpropane, pentaerythritol, glycerol and the like maybe used, if desired. When using 1,4-cyclohexanedimethanol, it may be the cis, trans or cis/trans mixtures. When using phenylenedi(oxyacetic acid), it may be used as 1,2; 1,3; 1,4 isomers, or mixtures thereof.

The polymer may also contain small amounts of trifunctional or tetrafunctional comonomers to provide controlled branching in the polymers. Such comonomers include trimellitic anhydride, trimethylolpropane, pyromellitic dianhydride, pentaerythritol, trimellitic acid, trimellitic acid, pyromellitic acid and other polyester forming polyacids or polyols generally known in the art.

Suitable polyamides include partially aromatic polyamides, aliphatic polyamides, wholly aromatic polyamides and/or mixtures thereof. By “partially aromatic polyamide,” it is meant that the amide linkage of the partially aromatic polyamide contains at least one aromatic ring and a nonaromatic species. Suitable polyamides have an article forming molecular weight and preferably an I.V. of greater than 0.4.

Preferred wholly aromatic polyamides comprise in the molecule chain at least 70 mole % of structural units derived from m-xylylene diamine or a xylylene diamine mixture comprising m-xylylene diamine and up to 30% of p-xylylene diamine and an aliphatic dicarboxylic acid having 6 to 10 carbon atoms, which are further described in Japanese Patent Publications No. 1156/75, No. 5751/75, No. 5735/75 and No. 10196/75 and Japanese Patent Application Laid-Open Specification No. 29697/75.

Polyamides formed from isophthalic acid, terephthalic acid, cyclohexanedicarboxylic acid, meta- orpara-xylylene diamine, 1,3- or 1,4-cyclohexane(bis)methylamine, aliphatic diacids with 6 to 12 carbon atoms, aliphatic amino acids or lactams with 6 to 12 carbon atoms, aliphatic diamines with 4 to 12 carbon atoms, and other generally known polyamide forming diacids and diamines can be used. The low molecular weight polyamides may also contain small amounts of trifunctional or tetrafunctional comonomers such as trimellitic anhydride, pyromellitic dianhydride, or other polyamide forming polyacids and polyamines known in the art,

Preferred partially aromatic polyamides include, but are not limited to poly(m-xylylene adipamide), poly(m-xylylene adipamide-co-isophthalamide), poly(hexamethylene isophthalamide), poly(hexamethylene isophthalamide-co-terephthalamide), poly(hexamethylene adipamide-co-isophthalamide), poly(hexamethylene adipamide-co-terephthalamide), poly(hexamethylene isophthalamide-co-terephthalamide) and the like or mixtures thereof. More preferred partially aromatic polyamides include poly(m-xylylene adipamide), poly(hexamethylene isophthalamide-co-terephthalamide), poly(m-xylylene adipamide-co-isophthalamide), and/or mixtures thereof. The most preferred partially aromatic polyamide is poly(m-xylylene adipamide).

Preferred aliphatic polyamides include, but are not limited to poly(hexamethylene adipamide) and poly(caprolactam). The most preferred aliphatic polyamide is poly(hexamethylene adipamide). Partially aromatic polyamides are preferred over the aliphatic polyamides where good thermal properties are crucial.

Preferred aliphatic polyamides include, but are not limited to polycapramide (nylon 6), poly-aminoheptanoic acid (nylon 7), poly-aminonanoic acid (nylon 9), polyundecaneamide (nylon 11), polyaurylactam (nylon 12), poly(ethylene-adipamide) (nylon 2,6), poly(tetramethylene-adipamide) (nylon 4,6), poly(hexamethylene-adipamide) (nylon 6,6), poly(hexamethylene-sebacamide) (nylon 6,10), poly(hexamethylene-dodecamide) (nylon 6,12), poly(octamethylene-adipamide) (nylon 8,6), poly(decamethylene-adipamide) (nylon 10,6), poly(dodecamethylene-adipamide) (nylon 12,6) and poly(dodecamethylene-sebacamide) (nylon 12,8)

The most preferred polyamides include poly(m-xylylene adipamide), polycapramide (nylon 6) and polyhexamethylene-adipamide (nylon 6,6). Poly(m-xylylene adipamide) is a preferred polyamide due to its availability, high barrier, and processability.

The polyamides are generally prepared by processes that are well known in the art.

The polymers of the present invention may also include additives normally used in polymers. Illustrative of such additives known in the art are colorants, pigments, carbon black, glass fibers, fillers, impact modifiers, antioxidants, stabilizers, flame retardants, reheat aids, crystallization aids, acetaldehyde reducing compounds, recycling release aids, oxygen scavengers, plasticizers nucleators, mold release agents, compatibilizers, and the like, or their combinations.

The amount of particles incorporated into the polymer depends upon the particular polymer and colorant used. For example, the particles may be incorporated into a polymer in an amount up to about 80% by weight, such as about 50% by weight, especially when forming polymeric films from dissolved polymers. In other embodiments, the particles may be incorporated into the polymeric material in an amount up to about 20% by weight, such as in an amount up to about 10% by weight. When present in the polymer in order to improve the gas barrier properties of the polymer, typically it is desirable to add as little of the particles as possible while maximizing the light fastness of the colorant. In general, the greater the amount of exfoliation of the particles in the polymer the less particles are needed in order to increase the light fastness of the colorant. Of particular advantage, since synthetic oxide particles and metal phosphonate particles may be easily exfoliated in liquids, relatively low loading of the particles may significantly improve the gas barrier properties of the material in some applications. In these applications, for instance, the particles may be present in the polymer matrix in an amount less than about 5% by weight, such as in an amount from about 0.5% to about 3% by weight.

In one particular embodiment of the present invention, the particles may be incorporated into a polymeric material at relatively high loading. Once dispersed in the polymeric material, the polymeric material and particles mixture may be combined with greater amounts of the polymeric material or with a second polymeric material (e.g., a colored polymeric material) until a desired loading of the particles is achieved.

For example, in one embodiment, the particles may be incorporated into a polymeric material in an amount greater than about 5% by weight, such as in an amount from about 10% to about 20% by weight. Once the particles are dispersed within the polymeric matrix, for instance, the polymer may be pelletized. The pellets containing the particles may then be combined with polymer pellets not containing the particles. Both pellets may then be melt processed together at a selected ratio in order to arrive at an overall particle loading, such as less than about 5%. It is believed that once the particles are exfoliated and dispersed within a polymer, greater amounts of the same polymer or a different polymer may be added later during a melt processing operation and the particles will remain uniformly dispersed through the resulting material. This embodiment of the present invention may provide various processing advantages. For example, when forming polyester articles, such as polyester containers, only a portion of the polyester monomer may need to be polymerized with the particles. The remaining polyester needed to reach the desired loading level may then be added later during formation of the article being produced.

In one particular application, for instance, the particles may be incorporated into a lower molecular weight PET at a relatively high weight loading, such as from about 20% to about 30% by weight. The nanocomposite material may then be diluted using high molecular weight PET via extrusion such that the resulting material has a particle loading of from about 1% to about 5% by weight. The low molecular weight PET and the high molecular weight PET are physically mixed and then extruded to form a PET nanocomposite having the particles dispersed therein.

In another particular embodiment, the polymeric material can include a hydrogel polymer. Generally, a hydrogel is a network of hydrophilic polymers. For instance, hydrogels are insoluble, hydrophilic water-containing gels, which are made from water-soluble polymers. The hydrogel polymers are typically cross-linked, such as chemically cross-linked or physically cross-linked. Physical gels are generally “weaker” than chemical gels. For example, the physical cross-linking of a gel can be destroyed by adding large amounts of solvent. Physically cross-linked hydrogels form polymeric networks with non-covalent interactions, such as ionic bonds, hydrogen bonds, hydrophobic associations, dipole-dipole interactions, and van der Waals forces. For example, poly(vinyl alcohol) (PVA) can be a physically cross-linked hydrogel (though chemically cross-linked PVA networks also exist). Another example of a physically cross-linked hydrogel is agarose. Agarose is a natural linear polysaccharide and forms thermally reversible gels. According to this embodiment, the nanoparticles are selected to be compatible with the hydrogel polymers. For example, hectorite is compatible with hydrogel polymers due to its hydrophilic character.

Once the particles are incorporated into a polymer matrix, the polymeric composite material may be used in various applications. The polymeric composite material may be formed, for instance, into films, fibers, filaments, and into various molded or extruded articles. In one particular application, for instance, the particles may be incorporated into a polyester for forming beverage containers. In another embodiment, the particles may be incorporated into a polymer for forming medical devices, such as devices that are intended to hold or carry blood.

### Colorants

Colorants useful according to the present invention can be any number of compatible colorants, including dyes and pigments. Colorants can be described by their Color Index name, which is an internationally recognized reference to a particular colorant. In one particular embodiment, the colorant is a dye, such as a dye compatible with the particular polymer matrix with which it is associated. Dyes can be classified into many different groups, such as ionic dyes, disperse dyes, vat dyes, and the like. Ionic dyes are typically ionic compounds used in aqueous solution, although some dyes (e.g., disperse dyes) are generally not water soluble.

Ionic dyes can be generally classified by the location of the actual coloring component on one or more of the ions. For example, acid dyes have the coloring component in the anion of the dye, while basic dyes have the coloring component in the cation. Neutral dyes have coloring components in both the anion and cation of the dye. Note that the terms “acid dye,” “basic dye,” and “neutral dye” do not describe the pH of a solution of the particular dye, but rather the location of the coloring component of the dye.

Acid dyes are well known as useful for dying fibers, such as silk, wool, nylon, and modified acrylic fibers. However, their use with polyesters has been somewhat limited due to poor light fastness properties. According to the present invention, however, the light fastness of acid dyes can be improved, even when used with polyesters, by the inclusion of synthetic nanoparticles. Acid dyes are thought to fix to fibers by hydrogen bonding and are normally sold as a sodium salt (thus, anionic in solution). It is believed that since natural fibers and synthetic nylon fibers contain many cationic sites, there is an attraction of the anionic dye to those cationic sites on the polymer.

Acid dyes encompass a wide variety of chemical compounds and classes. Usually, acid dyes have a sulphonyl or amino group on the molecule making them soluble in water. Acid dyes can include, but are not limited to, anthraquinone-based dyes, azo dyes, and triphenylmethane-based dyes.

Anthraquinone-based dyes, which include, but are not limited to many blue dyes, generally have a structure derived from the following base structure:

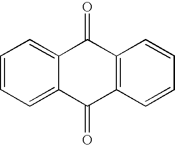

Azo dyes, which include, but are not limited to many red dyes, generally refer to dyes that have at least one azo group in the molecular structure. Azo dyes can be further sub-classified into monoazo, diazo, triazo dyes, and so forth, according to the number of azo groups in the molecule. For example, the first three classifications of azo dyes can be generalized according to the following formulas:

R—N═N—R′ monoazo

R—N═N—R′—N═N—R″ diazo

R—N═N—R′—N═N—R″—N═N—R″′ triazo

wherein R is a cation, H, or an organic group (including both aromatic and aliphatic groups). In many applications, the R groups are aromatic, such as phenyl or phenyl-based groups. It is commonly believed in the art that the delocalization of the electrons in aromatic groups and the azo groups allows the conjugated molecule to absorb visible frequencies of light.

An exemplary diazo acid dye is Acid Red #111 )2,7-naphthalenedisulfonic acid, 3-[[2,2′-dimethyl-4′-[[4-[[(4-methylphenyl)sulfonyl]oxy]phenyl]azo][1,1′-biphenyl]4-yl]azo]-4-hydroxy-, disodium salt), which is represented by the structure below:

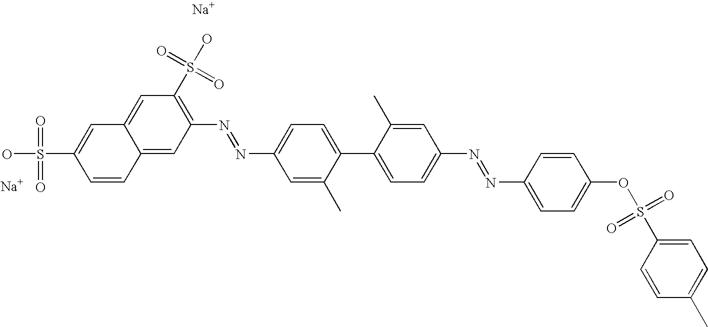

Triphenylmethane-based dyes, which include, but are not limited to many yellow and green dyes, are based on the molecule generally represented below:

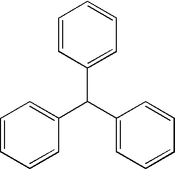

For example, a triphenylmethane-based dye can be Acid Violet #17, a standard dye used for testing light fastness, which is represented by the following structure:

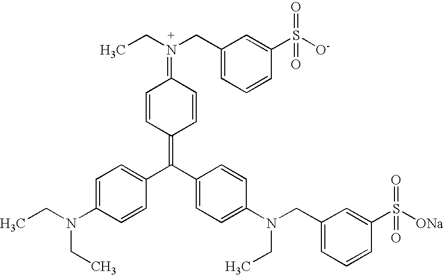

Other types of dyes can be used according to the present invention. For example, water-insoluble disperse dyes can be used in accordance with the present invention.

The dye or other colorant can be added to the polymeric material at any time during its processing. For example, the colorant can be added either before or after the nanoparticles have been added to the polymeric material. In most embodiments, the dye or other colorant will be incorporated into the polymeric matrix, along with the synthetic nanoparticles. The dye or colorant can be added to the polymeric material according to any process.

The amount of dye or colorant present within the polymeric material can be any amount sufficient to add the desired color to the polymeric material. In fact, the amount of dye or other colorant may be dependent on the particular type of colorant and/or the particular polymeric material used. In most embodiments, the amount of colorant added to the polymeric material is relatively low, such as less than about 5 weight %, such as less than about 3 weight %. For example, in some particular embodiments, the dye can be added to the polymeric material in an amount of from about 0.01 weight % to about 2 weight %, such as from about 0.1 weight % to about 1 weight %.

### Polymer Nanocomposite Films with Improved Light Fastness

The present inventors have discovered that through careful selection of synthetic nanoparticles, the colored nanocomposite materials described herein can have improved light fastness over films comprising the colored polymer with no additional additives.

In general, light fastness refers to the degree to which a dye (or other colorant) resists fading due to exposure to light. Commonly, lightfastness is judged on a scale of 1 to 8, where 8 is most fade-resistant, although other scales are used. Different colorants have different degrees of resistance to fading by light. For example, all dyes have some susceptibility to light damage, simply because they absorb the wavelengths that they don't reflect back. This absorption of light, which is a form of energy, can serve to degrade the dye molecule.

However, other mechanisms can also contribute to the degradation of the dye molecule. For instance, in some cases, oxygen is required for the damaging reactions of dye chemicals that are caused by light. This is commonly referred to in the art as the photodynamic effect. Without wishing to be bound by theory, it is believed that the photodynamic effect can particularly contribute to the degradation of azo dyes by oxidizing the azo bonds in the dye molecule. For insance, azo dyes may undergo azo-hydrazone tautomerism in the presence of oxygen, which contributes to the fading of the dye.

Thus, due to the improved gas barrier properties of the polymer films having the synthetic nanoparticles described above, the dyed composite polymer materials of the present invention can be particularly useful to provide improved light fastness to dyes susceptible to photodynamic effects in the presence of oxygen.

Alternatively, another theory suggests that the presence of UV, or other light wavelengths, absorbers in the polymer matrix can increase the light fastness of the dye. For example, the synthetic nanoparticle may act as a UV stabilizer, and thus contribute to the light fastness of the dyed polymer matrix. In another theory, the dyes may be intercalated into the nanoparticle structure, which may further stabilize the dye.

According to the present invention, the amount of nanoparticles and colorant present in the polymeric material can be adjusted in order to maximize the light fastness of the colored polymeric composite material formed therefrom. For example, depending upon the characteristics of the particular dye used in the polymeric material, a certain nanoparticle can be added in a certain amount in order to maximize its light fastness. For instance, acid dyes, and particularly azo dyes, which are susceptible to degradation when exposed to light in the presence of oxygen, can be included into a polymeric material that comprises hectorite in order to maximize the light fastness of the formed colored polymeric material.

The light fastness of the colored polymeric composite material including the synthetic nanoparticles can be greater than the light fastness of an identical colored polymeric material without the synthetic nanoparticles present. For example, the presence of the synthetic nanoparticles can increase the light fastness of the colored polymeric material by at least 5%, such as at least 10% when exposed to light for at least 72 hours.

The present invention may be better understood with respect to the following examples:

### EXAMPLES

As discussed in greater detail below, to demonstrate the enhanced light fastness (i.e. resistance to fading), exemplary synthetic nanoparticles were exfoliated in water. A certain amount of polymer, either agarose or polyvinyl alcohol, was added to the material. The mixture was stirred and heated to melt the polymer. Dye was added to the mixture before it was allowed to dry. The films were obtained after the mixture was dried. The films were exposed to light and compared to control films that do not contain the exfoliated material. Films containing the exfoliated composite material consistently showed improved light fastness over the control films.

### Example 1

### Synthesis of a Perovskite: KCa₂Nb₃O₁₀

Potassium calcium niobium oxide (KCa₂Nb₃O₁₀) was made via a conventional solid state reaction of K₂CO₃ (1 mmol+20% excess) CaCO₃ (2 mmol) and Nb₂O₅ (1.5 mmol). The mixture was heated to 790° C. for 12 hours, cooled, and heated again to 1250° C. for 24 hours. KCa₂Nb₃O₁₀ was also synthesized using a KCl flux. The same amount of reactants were used and the mixture was heated to 900° C. for 12 hours. The KCl was then added and the mixture was heated to 1000° C. at a rate of 10°/min for 12 hours. All syntheses can be scaled up as needed.

### Exfoliation

KCa₂Nb₃O₁₀ was first dispersed into water (1 wt. %). Then the mixture was heated and stirred for 24 hours. Next the mixture was sonicated for 15 minutes and then centrifuged for 15 minutes to removes larger agglomerated particles. The supernatent was again heated and stirred for one hour, sonicated for 15 minutes, and centrifuged for 15 minutes. This process was repeated up to 3 times, at which time the final mixture was centrifuged at high speeds for 30 minutes.

### Preparation of Polymeric Film

An amount of agarose was added to the exfoliated suspension so that the weight percentage of layered material in polymer was 5 weight %. These mixtures were vigorously stirred and heated enough to melt the polymer. Once the polymer was melted and thoroughly dispersed, 0.2 wt. % of dye was added. After the dyed mixtures were cooled, they were poured into Petri dishes and allowed to dry at 55° C. overnight. Control systems for each dye were made via the same method without the addition of exfoliated layered materials.

### Example 2

### Synthesis of a Hectorite

Hectorite was synthesized by refluxing LiF (1.32 mmol), Mg(OH)₂ (5.34 mmol), and a silical source (usually silical sol, 8 mmol) for 48 hours. First LiF was dissolved in water, then Mg(OH)₂ was added and stirred for at least one half an hour, and finally the silica sol was added.

To modify the hectorite, other silanes were used in the synthesis as part of the silica source (typically 50/50 with the silica sol). These include tetraethoxy silane (TEOS) and phenyltriethoxysilane (PTES).

To incorporate other cations such as K⁺, Na⁺, or TEA⁺, the respective salt was added to the starting materials (0.2 to 0.8 mmol) and the amount added would be removed from the amount of LiF added.

Hectorite can also be synthesized hydrothermally in a Parr reaction vessel for 24 hours using the same ratios of starting materials. All syntheses can be scaled up as needed.

Control systems for each dye were made via the same method without the addition of the hectorite.

### Exfoliation and Preparation of Polymeric Film

The methods for exfoliation and polymer preparation of composite films containing hectorite are the same as the above methods for perovskites, except that films of polyvinyl alcohol (PVA) and agarose were prepared.

### Example No. 3

### Synthesis of a Phosphonate: Ti(O₃PCH₂CH₂COOH)₂

8.01 grams of 2-carboxyethylphosphonic acid was dissolved in approximately 104 mL of distilled water. Meanwhile in a separate beaker 2.86 mL of TiCl₄ was added into an at least a 6M HCl solution made by dissolving approximately 47 mL of concentrated HCl with 47 mL of distilled water. The titanium solution was then added into the solution containing the dissolved phosphonic acid and the reflux was started and continued for at least 24 hours.

### Exfoliation of the Ti(O₃PCH₂CH₂COOH)₂ into Water

0.5 grams of the phosphonate was added into an aqueous solution containing a calculated amount of NaOH and stirred on ice for 2 hours. The solution was then sonicated for at least one hour and stirred and sonicated a second time if desired. The sample was then centrifuged at 2500 rpm for 20 min at least one time to remove any un-exfoliated particles. The remaining solution contained particles which were exfoliated and included tactoids.

Control systems for each dye were made via the same method without the addition of the phosphonate particles.

### Preparation of Polymeric Film

The methods for polymer preparation of composite films containing phosphonate are the same as the above methods for perovskites.

### Dyes

The following dyes were used in the various polymeric composite films: yellow, acid violet #17, and acid red #111. The dyes were added as described above, except that for the acid red #111 dyed films, the acid red was added at a concentration of 0.1 wt. %.

The following systems were investigated:

| Additive | Polymer | Dye | Label |
|---|---|---|---|
| Hectorite | PVA | Yellow | HPY |
| Hectorite | PVA | Acid Violet #17 | HPV |
| Hectorite | PVA | Acid Red #111 | HPR |
| Hectorite | Agarose | Yellow | HAY |
| Hectorite | Agarose | Acid Violet #17 | HAV |
| Hectorite | Agarose | Acid Red #111 | HAR |
| Phosphonate | Agarose | Yellow | PHAY |
| Phosphonate | Agarose | Acid Violet #17 | PHAV |
| Perovskite | Agarose | Yellow | PAY |
| Perovskite | Agarose | Acid Violet #17 | PAV |

All of the yellow dyed Agarose nanocomposite films and their respective control films were exposed to natural light. Half of the films were also covered and placed into a dark drawer. After a period of several days, all of the control films faded noticeably. The hectorite films (HAY) did not fade at all. The perovskite films (PAY) faded although not as significantly as the control. Phosphonate films (PHAY) did not seem to show any resistance to fading.

The hectorite in Agarose films (HAV) dyed with Acid Violet #17 were also exposed to natural light. However, none of the films including the controls faded over and extended period of several days.

Next, all of the Agarose films were placed in a control UV light chamber. After 24 hours, none of the films faded.

The hectorite in PVA films (HPY and HPV) were placed inside a slide projector to expose them to an intense light source. Initial observations indicate that the control films faded whereas the films containing hectorite showed improve fade resistance. Perovskite in Agarose films (PAY) also showed improved fade resistance compared to the respective control film.

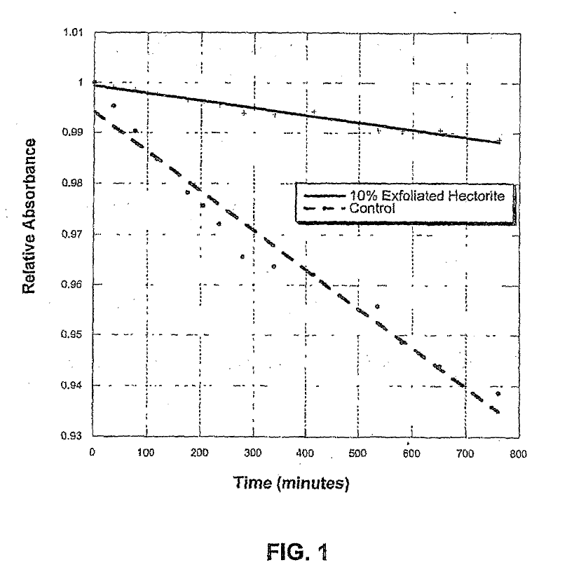

The HPR film was exposed to UV light (wavelength=254 nm) by a UV lamp and UV-VIS measurements. From UV-VIS the intensity of the peak for the dye can be measured over time. The results, when compared to a control polyvinyl alcohol film containing acid red #111 without any hectorite, are shown in FIG. 1, and indicate that the presence of hectorite in the dyed polyvinyl alcohol film improves the light fastness of the acid red dye.

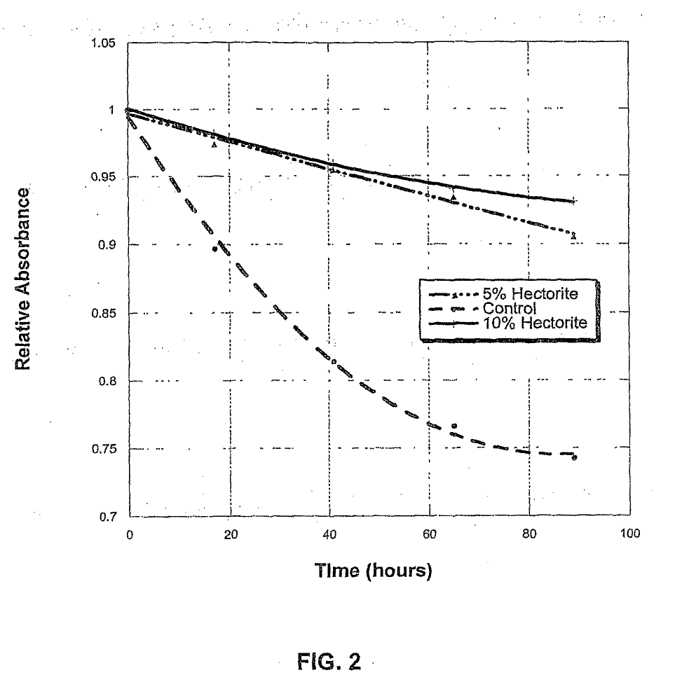

The HAR film was put into a “sunbox” chamber (Atlas Suntest XLS), which imitates sunlight at the equator at noon. The results, when compared to a control agarose film containing acid red #111 without any hectorite, are shown in FIG. 2, and indicate that the presence of hectorite in the dyed agarose film improves the light fastness of the acid red dye.

The foregoing description of the invention and examples along with other modifications and variations to the present invention may be practiced by those of ordinary skill in the art, without departing from the spirit and scope of the present invention. In addition, it should be understood that aspects of the various embodiments may be interchanged, both in whole, or in part. Furthermore, those of ordinary skill in the art will appreciate that the foregoing description is by way of example only, and is not intended to limit the invention so further described in such appended claims.

What is claimed is:

1. A colored polymeric material comprising
a polymer;
synthetic nanoparticles having a greatest dimension of less than about 5,000 nm, wherein said synthetic nanoparticles are selected from the group consisting of synthetic oxide particles and metal phosphonate particles; and
a colorant, wherein the colored polymeric material has increased light fastness when compared to an otherwise identical colored control polymeric material without said synthetic nanoparticles.

2. A colored polymeric material as in claim 1, wherein said colorant comprises a dye.

3. A colored polymeric material as in claim 2, wherein said dye comprises an acid dye.

4. A colored polymeric material as in claim 2, wherein said dye comprises an azo dye.

5. A colored polymeric material as in claim 1, wherein said dye is susceptible to degradation when exposed to light in the presence of oxygen.

6. A colored polymeric material as in claim 1, wherein said synthetic nanoparticles comprise synthetic oxide particles selected from the group consisting of synthetic phyllosilicate particles and synthetic layered perovskite particles.

7. A colored polymeric material as in claim 1, wherein said synthetic nanoparticles comprise smectites.

8. A colored polymeric material as in claim 1, wherein said synthetic nanoparticles comprise hectorites.

9. A colored polymeric material as in claim 1, wherein said dye comprises from about 0.01 weight % to about 5 weight % of the polymeric material.

10. A colored polymeric material as in claim 1, wherein said synthetic nanoparticles comprise from about 0.1 weight % to about 10 weight % of the polymeric material.

11. A colored polymeric material as in claim 1 wherein the polymeric material defines a film.

12. A colored polymeric material as in claim 1, wherein said polymer is selected from the group consisting of polyesters, polyetheresters, polyamides, polyesteramides, polyurethanes, polyimides, polyetherimides, polyureas, polyamideimides, polyphenyleneoxides, phenoxy resins, epoxy resins, polyolefins, polyacrylates, polystyrenes, polyethylene-co-vinyl alcohols, polyvinyl chlorides, polyvinyl alcohols, cellulose acetates, agarose, and copolymers and combinations thereof.

13. A dyed polymeric material comprising
a polymer selected from the group consisting of polyesters, polyetheresters, polyamides, polyesteramides, polyurethanes, polyimides, polyetherimides, polyureas, polyamideimides, polyphenyleneoxides, phenoxy resins, epoxy resins, polyolefins, polyacrylates, polystyrenes, polyethylene-co-vinyl alcohols, polyvinyl chlorides, polyvinyl alcohols, cellulose acetates, agarose, and copolymers and combinations thereof;
synthetic oxide nanoparticles having a greatest dimension of less than about 5,000 nm; and
an dye, wherein the dyed polymeric material has increased light fastness when compared to an otherwise identical dyed control polymeric material without said synthetic nanoparticles.

14. A dyed polymeric material as in claim 13, wherein said synthetic oxide nanoparticles are selected from the group consisting of synthetic phyllosilicate particles and synthetic layered perovskite particles.

15. A dyed polymeric material as in claim 13, wherein said synthetic oxide nanoparticles comprise smectites.

16. A dyed polymeric material as in claim 13, wherein said synthetic oxide nanoparticles comprise hectorites.

17. A dyed polymeric material as in claim 13, wherein said dye comprises from about 0.01 weight % to about 5 weight % of the polymeric material.

18. A dyed polymeric material as in claim 13, wherein said synthetic oxide nanoparticles comprise from about 0.1 weight % to about 10 weight % of the polymeric material.

19. A dyed polymeric material as in claim 13, wherein said dye comprises an acid dye that is susceptible to degradation when exposed to light in the presence of oxygen.

20. A method of making a colored polymeric material having increased light fastness, the method comprising:
exfoliating synthetic nanoparticles into a polymeric material, wherein said synthetic nanoparticles have a greatest dimension of less than about 5,000 nm and are selected from the group consisting of synthetic oxide particles and metal phosphonate particles;
dying the polymeric material with a dye that is susceptible to degradation when exposed to light in the presence of oxygen.
